(19) United States
(12) Patent Application Publication
(10) Pub. No.: US 2022/0006418 A1
(43) Pub. Date: Jan. 6, 2022

(54) MOTOR CONTROL SYSTEM, UNMANNED AERIAL VEHICLE, MOVING VEHICLE, AND MOTOR CONTROL METHOD

(71) Applicant: Panasonic Intellectual Property Management Co., Ltd., Osaka-shi, Osaka (JP)

(72) Inventor: Daisuke Sato, Osaka (JP)

(73) Assignee: Panasonic Intellectual Property Management Co., Ltd., Osaka-shi, Osaka (JP)

(21) Appl. No.: 17/295,107

(22) PCT Filed: Oct. 18, 2019
(86) PCT No.: PCT/JP2019/041221

§ 371 Date: May 19, 2021

(30) Foreign Application Priority Data
Nov. 21, 2018 (JP) 2018-218504

(51) Int. Cl. H02P 29/028; H02K 11/35; B64F 5/60; B64D 31/00; B64C 39/02

(52) U.S. Cl. CPC H02P 29/028; H02K 11/35; B64C 2201/027; B64D 31/00; B64C 39/024; B64F 5/60

(57) ABSTRACT

A motor control system includes a motor and a motor control device. The motor control device includes an acquisition unit, a. diagnosis unit, and a control unit. The acquisition unit acquires control data. The control data includes a command, transmitted from each of a plurality of controllers, with respect to the motor. The plurality of controllers are configured to communicate with the motor control device. The diagnosis unit makes a diagnosis of multiple sets of the control data provided by the plurality of controllers and acquired by the acquisition unit. The control unit controls the motor by using a single set of control data selected based on a result of the diagnosis made by the diagnosis unit from the multiple sets of the control data.

### TECHNICAL FIELD

The present disclosure generally relates to a motor control system, an unmanned aerial vehicle (drone), a moving vehicle, and a motor control method.

### BACKGROUND ART

Patent Literature 1 discloses an unmanned aerial vehicle. The unmanned aerial vehicle includes: a motor; a propeller to be driven by the motor; a flight controller for generating a control signal for controlling the operation of the motor; and a main electric speed controller (ESC) and a sub-ESC for driving the motor in accordance with the control signal. The unmanned aerial vehicle further includes a failure detector for detecting any failure in the main ESC.

In this unmanned aerial vehicle, when any failure is detected in the main ESC, the destination of the control signal from the flight controller is changed from the main ESC to the sub-ESC, thereby having the motor driven by the sub-ESC.

Once a failure has occurred in the flight controller (controller), it is difficult for the unmanned aerial vehicle (motor control system) of Patent Literature 1 to continue controlling the motor.

### CITATION LIST

### Patent Literature

Patent Literature 1: JP 2018-50419 A

### SUMMARY OF INVENTION

It is therefore an object of the present disclosure to provide a motor control system, an unmanned aerial vehicle, a moving vehicle, and a motor control method, all of which are configured or designed to facilitate controlling a motor continuously.

A motor control system according to an aspect of the present disclosure includes a motor, and a motor control device provided for the motor. The motor control device includes an acquisition unit, a diagnosis unit, and a control unit. The acquisition unit acquires control data. The control data includes a command, transmitted from each of a plurality of controllers, with respect to the motor. The plurality of controller are configured to communicate with the motor control device. The diagnosis unit makes a diagnosis of multiple sets of the control data provided by the plurality of controllers and acquired by the acquisition unit. The control unit controls the motor by using a single set of control data, selected based on a result of the diagnosis made by the diagnosis unit, from the multiple sets of the control data.

An unmanned aerial vehicle according to another aspect of the present disclosure includes a plurality of motors, a plurality of motor control devices, and a controller. The plurality of motors spin a plurality of propellers, respectively. The plurality of motor control devices control the plurality of motors, respectively. The controller is configured to communicate with the plurality of motor control devices and transmits control data, including commands with respect to the plurality of motors, to the plurality of motors. The plurality of motors are classified into multiple motor groups. Each of the multiple motor groups includes two or more motors. Each of the plurality of motor control devices includes a self-diagnosis unit to make a diagnosis of the motor control device itself. When there is any motor control device to be selected based on a result of self-diagnosis by the self-diagnosis unit, the controller stops running a particular one of the motors that is associated with the motor control device and at least one more of the motors that belongs to the same motor group as the particular motor.

A moving vehicle according to still another aspect of the present disclosure includes the motor control system described above, and a moving mechanism to move when the motor is driven.

A motor control method according to yet another aspect of the present disclosure includes making a diagnosis of control data. The control data includes a command, transmitted from each of a plurality of controllers, with respect to a motor. The motor control method includes controlling the motor by using a single set of control data, which is selected based on a result of diagnosis from multiple sets of the control data provided by the plurality of controllers.

### BRIEF DESCRIPTION OF DRAWINGS

FIG. 1 is a block diagram illustrating a general configuration for a motor control system according to an exemplary embodiment of the present disclosure;

FIG. 2 illustrates a schematic configuration for an unmanned aerial vehicle including the motor control system;

FIG. 3 illustrates the content of control data transmitted from a controller in the motor control system;

FIG. 4 illustrates the content of response data transmitted from a motor control device in the motor control system;

FIG. 5 is a flowchart showing how the motor control device operates in the motor control system; and

FIG. 6 is a flowchart showing how the controller operates in the motor control system.

### DESCRIPTION OF EMBODIMENTS

(1) Overview

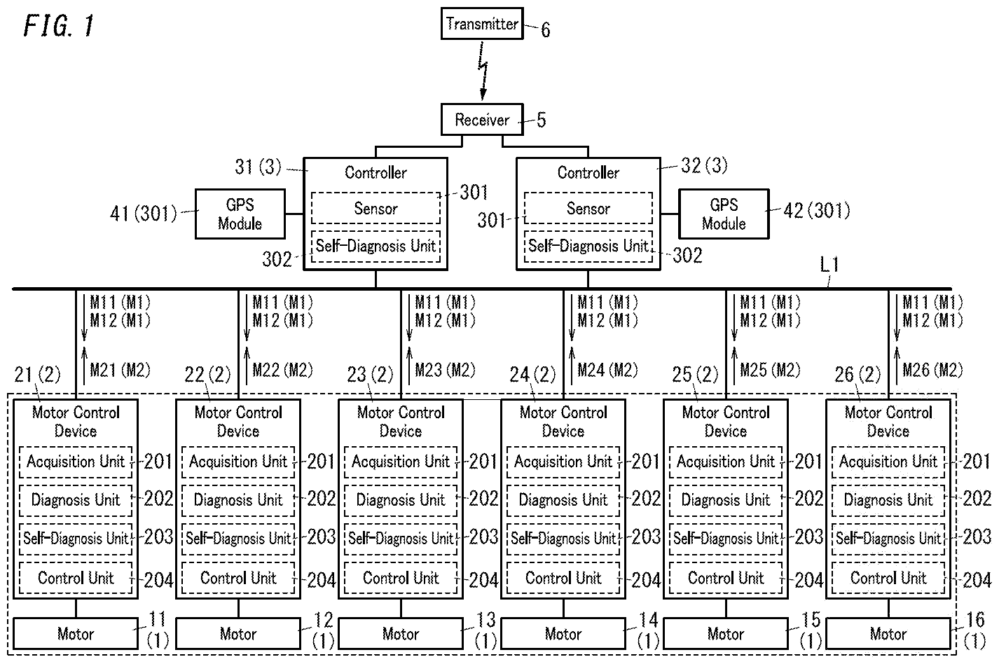

A motor control system 10 according to an exemplary embodiment includes a motor 1 and a motor control device 2 provided for the motor 1 as shown in FIG. 1.

As shown in FIG. 1, the motor control device 2 includes an acquisition unit 201, a diagnosis unit 202, and a control unit 204.

The acquisition unit 201 acquires control data M1. The control data M1 includes a command A0 (see FIG. 3), transmitted from each of a plurality of (e.g., two in the example illustrated in FIG. 1) controllers 3, with respect to the motor 1. The plurality of controllers 3 are configured to communicate with the motor control device 2. In the following description, when the plurality of controllers 3 need to be distinguished from each other, the controllers 3 will be hereinafter referred to as “controllers 31, 32.” Also, in the following description, when the control data M1 transmitted from the controllers 31, 32 need to be distinguished from each other, the control data M1 will be hereinafter referred to as “control data M11, M12.” That is to say, in this embodiment, the controllers 31, 32 respectively transmit the control data M11, M12 to the motor control device 2. In addition, in this embodiment, the controllers 31, 32 have the same configuration and the control data M11, M12 transmitted from the controllers 31, 32 are the same unless there is any abnormality. As used herein, if some data is “the same as” another data, these two data may be naturally be quite the same but may also be slightly different to the extent that the data receiver may behave in the same way, no matter which of the two data the data receiver receives.

The diagnosis unit 202 makes a diagnosis of multiple sets of the control data M1 provided by the plurality of controllers 3 and acquired by the acquisition unit 201. In this embodiment, the diagnosis unit 202 makes a diagnosis of the control data M11 provided by the controller 31 and the control data M12 provided by the controller 32.

The control unit 204 controls the motor 1 by using a single set of contra data M1 selected based on a result of the diagnosis DC0 (see FIG. 4) made by the diagnosis with 202 from the multiple sets of control data M1. For example, the motor control device 2 may control the motor 1 by using a single set of control data M1, which has been determined to be errorless based on a result of diagnosis DC0 made by the diagnosis unit 202, out of the two sets of control data M11, M12 transmitted from the controllers 31, 32, respectively.

As described above, according to this embodiment, the control unit 204 controls the motor 1 by using a single set of control data M1 selected based on a result of the diagnosis DC0 made by the diagnosis unit 202 from the multiple sets of control data M1. Suppose that the diagnosis unit 202 has diagnosed that the control data M11 transmitted from one controller 31, out of the plurality of controllers 3, should have an error. In that case, the control unit 204 may control the motor 1 by using the control data M12 transmitted from the controller 32, which is different from the controller 31 that is the source of the control data M11 diagnosed to be erroneous. Thus, this embodiment achieves the advantage of facilitating controlling the motor 1 continuously.

(2) Details

Next, the motor control system 10 according to this embodiment will be described in detail. As shown in FIG. 1, the motor control system 10 according to this embodiment includes a plurality of (e.g., six in the example illustrated in FIG. 1) motors 1 and a plurality of (e.g., six in the example illustrated in FIG. 1) motor control devices 2 provided for the plurality of motors 1, respectively. Thus, in this embodiment, the motor 1 includes a plurality of motors 1 and the motor control device 2 includes a plurality of motor control devices 2. Each of the plurality of motor control devices 2 controls an associated one of the plurality of motors 1.

In the following description, when the plurality of motors 1 need to be distinguished from each other, the plurality of motors 1 will be hereinafter referred to as “motors 11-16.” Also, in the following description, when the plurality of motor control devices 2 need to be distinguished from each other, the plurality of motor control devices 2 will be hereinafter referred to as “motor control devices 21-26.” That is to say, in this embodiment, the motor control devices 21-26 control their associated motors 11-16, respectively.

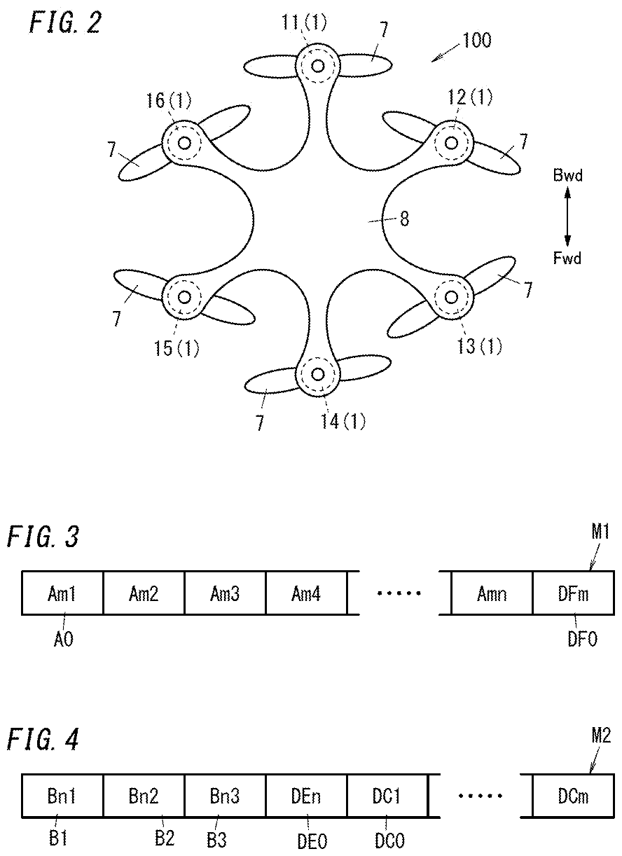

In the following description of embodiments, the motor control system 10 is supposed to be used to control the flight of an unmanned aerial vehicle (drone) 100 such as the one illustrated in FIG. 2. The unmanned aerial vehicle 100 is designed to fly in the air by spinning a plurality of (e.g., six in the example illustrated in FIG. 2) propellers (blades) 7 arranged around its airframe 8. The unmanned aerial vehicle 100 may be designed for industrial use, for example, e.g., for distribution, transportation, patrolling, inspection of buildings, or sprinkling agrichemical.

As shown in FIGS. 1 and 2, the unmanned aerial vehicle 100 includes a plurality of motors 1, a plurality of motor control devices 2 (see FIG. 1), and a plurality of controllers 3 (see FIG. 1). The plurality of motors 1 spin the plurality of propellers 7 (see FIG. 2), respectively. The plurality of motor control devices 2 are provided for the plurality of motors 1, respectively. Each of the plurality of controllers 3 is configured to communicate with the plurality of motor control devices 2 and transmits the control data M1, including commands A0 (see FIG. 3) for the plurality of motors 1, to the plurality of motors 1.

In this embodiment, the motors 11 and 14 are arranged to face each other diagonally, the motors 12 and 15 are arranged to face each other diagonally, and the motors 13 and 16 are arranged to face each other diagonally with the airframe 8 interposed between themselves, as shown in FIG. 2. That is to say, the motors 11 and 14 form one pair, the motors 12 and 15 form another pair, and the motors 13 and 16 form still another pain In other words, the plurality of (e.g., six in the example illustrated in FIG. 2) motors 1 are classified into multiple (e.g., three in the example illustrated in FIG. 2) motor groups, each of which includes two or more motors 1.

As shown in FIG. 1, the unmanned aerial vehicle 100 includes the controllers 31, 32, two global positioning system (GPS) modules 41, 42, a wireless communications device (receiver) 5, the motor control devices 21-26, the motors 11-16, and the propellers 7 (see FIG. 2). These members are mounted on the airframe 8 (see FIG. 2) of the unmanned aerial vehicle 100. Note that the controllers 31, 32, the two GPS modules 41, 42, the wireless communications device (receiver) 5, and the motor control devices 21-26 are housed in the airframe 8 (see FIG. 2). The motor control system 10 is formed by the motor control devices 21-26 and the motors 11-16. In this embodiment, the controllers 31 and 32 are constituent elements of the unmanned aerial vehicle 100 and are not counted among the constituent elements of the motor control system 10. However, this is only an example of the present disclosure and should not be construed as limiting. Alternatively, the controller 31 and 32 may also be counted among the constituent elements of the motor control system 10.

In this embodiment, the motor control devices 21-26 may all have the same configuration. Thus, the following description about the motor control device 2 is applicable to each of the motor control devices 21-26 unless otherwise stated. In the same way, in this embodiment, the controllers 31 and 32 both have the same configuration. Thus, the following description about the controller 3 is applicable to each of the controllers 31, 32 unless otherwise stated.

The motor control device 2 is implemented as an electric speed controller (ESC), for example, and includes the acquisition unit 201, the diagnosis unit 202, a self-diagnosis unit 203, and the control unit 204. In this embodiment, the motor control device 2 includes a computer system including, as principal hardware components, one or more processors and a memory. The respective functions of the diagnosis unit 202, the self-diagnosis unit 203, and the control unit 204 may be performed by making the one or more processors execute a program stored in the memory. The program may be stored in advance in the memory. Alternatively, the program may also be downloaded through a telecommunications line or be distributed after having been recorded in some non-transitory storage medium such as an optical disc or a hard disk drive, each of which is readable for the computer system. Furthermore, the acquisition unit 201 may be implemented as an input interface for the computer system.

The acquisition unit 201 acquires the control data M1 transmitted by the plurality of controllers 3. In this embodiment, the acquisition unit 201 acquires the control data M11, M12 transmitted from the controllers 31, 32. In addition, the acquisition unit 201 also acquires response data M2 transmitted from another motor control device 2.

In this embodiment, the communication may be established between the controllers 31, 32 and the motor control devices 21-26 in compliance with a communications protocol such as CAN with Flexible Data-rate (CAN FD), for example. In addition, the controllers 31, 32 and the motor control devices 21-26 are connected to a serial communications line L1 configured as a bus. In this embodiment, transmission of the control data M1 from the controllers 31, 32 to the motor control devices 21-26 and transmission of the response data M2 from the motor control devices 21-26 to the controllers 31, 32 are both carried out bidirectionally via the serial communications line L1. In the following description, when the response data M2 transmitted from the motor control devices 21-26 need to be distinguished from each other, the response data M2 will be hereinafter referred to as “response data M21-M26.”

As shown in FIG. 3, the control data M1 includes commands A0 (e.g., commands Am1, . . . , and Amn in this example) for the plurality of motors 1 and a result of self-diagnosis DF0 (e.g., result of self-diagnosis DFm in this example) made by the self-diagnosis unit 302 (to be described later) of the controller 3. In this embodiment, the command A0 corresponds to the target number of revolutions of the motor 1, where m is a natural number and the maximum value thereof corresponds to the number of controllers 3 and n is a natural number and the maximum value thereof corresponds to the number of the motors 1 (or the motor control devices 2). In this embodiment, the control data M11 transmitted from the controller 31 includes commands A11-A16 with respect to the motors 11-16 and a result of self-diagnosis DF1 made by the self-diagnosis unit 302 of the controller 31 (i.e., m=1 and n=6). Also, the control data M12 transmitted from the controller 32 includes commands A21-A26 with respect to the motors 11-16 and a result of self-diagnosis DF2 made by the self-diagnosis unit 302 of the controller 32 (i.e., m=2 and n=6). As can be seen, according to this embodiment, each of the multiple sets of control data M1 includes the result of self-diagnosis DF0 (see FIG. 3) made by the self-diagnosis unit 302 of its associated controller 3.

The response data M2 is a response to the control data M1. As shown in FIG. 4, the response data M2 includes measured values B1, B2, B3 (e.g., measured values Bn1, Bn2, Bn3 in this example) and a result of self-diagnosis DE0 (e.g., a result of self-diagnosis DEn in this example) made by the self-diagnosis unit 203 of the motor control device 2 as shown in FIG. 4. In addition, the response data M2 further includes a result of diagnosis DC0 (e.g., results of diagnosis DC1, . . . , DCm) made by the diagnosis unit 202 with respect to the control data M1. The measured values B1, B2, B3 respectively represent a measured value of the number of revolutions of the motor 1, a measured value of an electric current flowing through the coil of the motor 1, and a measured value of an ambient temperature of the motor 1. In this embodiment, the response data M21 transmitted from the motor control device 21, for example, includes the measured values B11, B12, B13 and the result of self-diagnosis DE1 made by the self-diagnosis unit 203 of the motor control device 21. The response data M21 further includes the results of diagnosis DC1, DC2 made by the diagnosis unit 202 with respect to the control data M11, M12. As can be seen, according to this embodiment, the motor control device 2 has the capability of transmitting the result of diagnosis DC0 made by the diagnosis unit 202.

In addition, as shown in FIG. 1, the acquisition unit 201 acquires another response data M2, transmitted from another motor control device 2, through the serial communications line L1. For example, the motor control device 21 acquires other response data M22-M26 transmitted from the other motor control devices 22-26. In this case, the other response data M2 includes the result of diagnosis DC0 made by the diagnosis unit 202 of another motor control device 2. That is to say, in this embodiment, each motor control device 2 acquires the result of diagnosis DC0 (see FIG. 4) made by the diagnosis unit 202 of another motor control device 2.

The diagnosis unit 202 makes a diagnosis of the control data M11, M12 provided by the controllers 31, 32 and acquired by the acquisition unit 201, the other response data M2 transmitted from the other motor control devices 2, and other types of data. This allows the diagnosis unit 202 to determine whether or not any of the controllers 31, 32, the other motor control devices 2, and other devices is operating improperly. The time it takes to make the diagnosis may be, for example, on the order of 1 μs to several ten μs. The diagnosis unit 202 calculates, for example, an instantaneous value, a variation per unit time, an average, a variance, and other values in accordance with a command (e.g., a target number of revolutions) A0. Next, the diagnosis unit 202 determines, with respect to each of these calculated values, whether or not the maximum value thereof is greater than a maximum threshold value and whether or not the minimum value thereof is less than a minimum threshold value. The maximum threshold value and minimum threshold value are set in advance with respect to each of these calculated values. Then, when finding the maximum value (or minimum value) of any one or more of these calculated values greater than the maximum threshold value thereof (or less than the minimum threshold value thereof), the diagnosis unit 202 decides that the command A0 should be faulty. Furthermore, if the next control data M1 cannot be detected within a predetermined period of time after the previous control data M1 has been acquired, the diagnosis unit 202 decides that the controller 3 that has output the control data M1 should be operating improperly. Also, if the next response data M2 cannot be acquired within a predetermined period of time since the previous response data M2 has been acquired, then the diagnosis unit 202 decides that the motor control device 2 that has output the response data M2 should be operating improperly.

Specifically, the unmanned aerial vehicle 100 including a plurality of propellers 7 as in this embodiment strikes a balance of its airframe 8 by finely changing the numbers of revolutions of the respective propellers 7 even while hovering in the air. Thus, a situation where the variation per unit time and variance of the command A0 become equal to zero usually cannot happen. That is why when finding any of the variation in unit time or variance that has been calculated less than the minimum threshold value, the diagnosis unit 202 decides that there should be some abnormality. In addition, even if the unmanned aerial vehicle 100 steeply rises, dives, or circles, the period in which the controller 3 transmits the control data M1 may also be as short as 1 ms to several ten ms. Therefore, a situation where the command A0 changes significantly on a period by period basis usually cannot happen. Consequently, when finding the variation per unit time that has been calculated greater than the maximum threshold value, the diagnosis unit 202 decides that there should be some abnormality. In addition, when the unmanned aerial vehicle 100 is carrying a heavyweight burden, the instantaneous value and average value of the command A0 increase compared to a situation where the unmanned aerial vehicle 100 is not carrying such a heavyweight burden, and therefore, a situation where the instantaneous value and average value of the command A0 become equal to zero usually cannot happen. Consequently, when finding either the instantaneous value or average value that has been calculated less than the minimum threshold value, the diagnosis unit 202 decides that there should be come abnormality.

The self-diagnosis unit 203 makes a diagnosis of the motor control device 2 itself that includes the self-diagnosis unit 203 (i.e., makes a self-diagnosis). Specifically, the self-diagnosis unit 203 makes a diagnosis of the respective conditions of a sensor, a microcontroller, an inverter circuit (not shown) for driving the motor 1, and other components, all of which are built in the motor control device 2. When finding at least one of these conditions abnormal, the self-diagnosis unit 203 decides that the motor control device 2 should be operating improperly,

The control unit 204 controls its associated motor 1 by using a single set of control data M1 selected, based on a result of the diagnosis DC0 made by the diagnosis unit 202, from the multiple sets of the control data M1 acquired by the acquisition unit 201. In this embodiment, unless the diagnosis unit 202 diagnoses that any of the control data M11, M12 should be erroneous, the control unit 204 controls its associated motor 1 by using the control data M11. Then, once the diagnosis unit 202 has decided that the control data M11 should be erroneous, the control unit 204 will control its associated motor 1 by using the control data M12 from then on, instead of the control data M11.

In some cases, the diagnosis unit 202 may decide that any of the multiple sets of control data M1 should be temporarily erroneous due to the presence of noise, for example. In that case, the control data M1 will recover a normal value with the passage of time. In addition, even if the diagnosis unit 202 decides that the control data M1 should be erroneous, the controller 3 continues transmitting the control data M1. Thus, if the diagnosis unit 202 decides that the control data M12 should be erroneous after having decided that the control data M11 should be erroneous and that the control data M11 has now recovered a normal value, then the control unit 204 may control its associated motor 1 by using the control data M11 again instead of the control data M12. Note that in that case, if the control data M11 maintains a normal value for a predetermined period of time (or a predetermined number of times) or more since the decision has been made that the control data M1 should be erroneous, the decision is suitably made that the controller 31 should have output the abnormal value just temporarily.

The control unit 204 controls, with reference to data, included in the single set of control data M1 selected, about the target number of revolutions of its associated motor 1, the motor 1 such that the number of revolutions of the associated motor 1 agrees with the target number of revolutions. For example, the control unit 204 of the motor control device 21 controls, with reference to data, included in the control data M11, about the target number of revolutions of its associated motor 11, the motor 11 such that the number of revolutions of the motor 11 agrees with the target number of revolutions.

In addition, the control unit 204 acquires the measured values B1, B2, and B3 based on the results of detection by various types of sensors built in the motor control device 2. Then, the control unit 204 generates response data M2 including the measured values B1, B2, B3, the result of diagnosis DC0 made by the diagnosis unit 202, and the result of self-diagnosis DE0 made by the self-diagnosis unit 203. The control unit 204 transmits the response data M2 thus generated to the plurality of controllers 3 at regular intervals via the serial communications line L1.

The controller 3 is a flight controller that adopts, for example, pulse width modulation as a communication method, and includes a sensor 301 and a self-diagnosis unit 302. In this embodiment, the controller 3 includes a computer system including, as principal hardware components, one or more processors and a memory. The function of the self-diagnosis unit 302 may be performed by making the one or more processors execute a program stored in the memory. The program may be stored in advance in the memory. Alternatively, the program may also be downloaded through a telecommunications line or be distributed after having been recorded in some non-transitory storage medium such as an optical disc or a hard disk drive, each of which is readable for the computer system.

The sensor 301 includes one or more sensors for detecting the state of the unmanned aerial vehicle 100. Examples of the one or more sensors 301 include: a gyrosensor for detecting the orientation of the unmanned aerial vehicle 100; an acceleration sensor for detecting the acceleration of the unmanned aerial vehicle 100; and a geomagnetic sensor for detecting the traveling direction of the unmanned aerial vehicle 100. In this embodiment, the sensor 301 built in the controller 31 and the sensor 301 built in the controller 32 have the same configuration. Thus, the results of detection by these sensors 301 are the same unless there is any particular abnormality.

In this embodiment, a GPS module 41 (or GPS module 42) to be described later also forms part of the sensor 301. In the following description, the sensor 301 built in the controller 31 (or the controller 32) and the GPS module 41 (or GPS module 42) will be hereinafter collectively referred to as the “sensor 301.”

In this embodiment, the controllers 31, 32 do not share the same sensor in common. In other words, the sensor 301 used in the controller 31 and the sensor 301 used in the controller 32 are independent of each other. That is to say, each of the plurality of controllers 3 generates the control data M1 based on the result of detection by an associated one of the plurality of sensors 301. The plurality of sensors 301 are associated one to one with the plurality of controllers 3.

The self-diagnosis unit 302 makes a diagnosis of the controller 3 itself that includes the self-diagnosis unit 302 (i.e., makes a self-diagnosis). Specifically, the self-diagnosis unit 302 makes a diagnosis of the respective conditions of the sensor 301 and the receiver 5. When finding at least one of these conditions abnormal, the self-diagnosis unit 302 decides that the controller 3 should be operating improperly. Note that once the self-diagnosis unit 302 has decided that the sensor 301 associated with the controller 3 itself should be operating improperly, the controller 3 may use, from then on, a result of detection by the sensor 301 associated with another controller 3.

The controller 3 generates, based on the result of detection by the sensor 301 and a main command (to be described later) from the receiver 5, commands A0 with respect to the respective motors 1. Then, the controller 3 generates control data M1 including the commands A0 and the result of self-diagnosis DF0 made by the self-diagnosis unit 302. The controller 3 broadcasts the control data M1 thus generated to the plurality of motor control devices 2 at regular intervals via the serial communications line L1. That is to say, each of the plurality of controllers 3 broadcasts the control data M1 to the plurality of motor control devices 2.

This aspect allows the respective motor control devices 2 to update the control data M1 (i.e., the commands A0) provided by the controller 3 almost simultaneously and in a short time. Suppose the plurality of controllers 3 sequentially unicast the control data M1 with respect to the plurality of motor control devices 2 one after another. In that case, if any of the motor control device 2 starts operating improperly, then a delay may be caused by the motor control device 2 that has started operating improperly. This may cause a delay in the update of the commands A0 in another motor control device 2, thus possibly causing a decline in the responsivity of the orientation control of the airframe 8 and in the stability of the orientation of the airframe 8 eventually. On the other hand, according to this aspect, even if any of the motor control devices 2 has started operating improperly, each of the other motor control devices 2 may cope with the situation immediately by updating the commands A0, thus more easily reducing the chances of causing a decline in the stability of the orientation of the airframe 8.

In addition, according to this embodiment, the controller 3 also has a balance diagnosis capability of making a diagnosis of the balance in operation between the plurality of motors 1. The balance diagnosis capability allows the controller 3 to observe every motor's 1 measured values B1, B2, B3 acquired from all the motor control devices 2 for a relatively long time while the unmanned aerial vehicle 100 is flying to determine whether or not there is any significant difference from one motor 1 to another. In this embodiment, the controller 3 calculates the variation per unit time, average, variance, and other values of every motor's 1 measured values B1, B2, B3 and determines, based on these calculated values, whether or not there is any imbalance in operation between the plurality of motors 1.

For example, if the measured value B2 (electric current value) of only one motor 1 is less than not only the total average (e.g the average of the electric current values of the six motors 1 in this example) but also the minimum threshold value, then it is highly probable that chipping has occurred in sortie of the propellers 7. In that case, the controller 3 decides that the propeller 7 connected to the motor 1 should be operating improperly. Also, if the measured value B2 of one motor 1 remains the same as the total average until the measured value B1 (number of revolutions) reaches a predetermined value but the measured value B2 does not increase with the number of revolutions once the number of revolutions has exceeded the predetermined value, then it is highly probable that the motor 1 is racing. In that case, the controller 3 decides that an error should have occurred due to the motor's 1 racing. Furthermore, if the measured value B2 of only one motor 1 is greater than the total average and greater than the maximum threshold value, then it is highly probable that the shaft of any propeller 7 or motor 1 has been deformed or foreign matter has been caught in the gap of a bearing of the motor 1 or the gap between the rotor and the stator. In that case, the controller 3 decides that an error should have occurred due to a partial deformation of the propeller 7 or the motor 1 or the presence of foreign matter. Furthermore, if the measured value B3 (temperature) of one motor 1 is greater than the total average (e.g., the average temperature of the six motors 1 in this example) and greater than the maximum threshold value, then it is highly probable that the magnet of the motor 1 has been demagnetized. In that case, the controller 3 decides that an error should have occurred due to the demagnetization of the magnet of the motor 1.

Note that it is difficult to make these error decisions with respect to an unmanned aerial vehicle 100 of which the motor's 1 load varies according to the weight of the burden, the shapes of the propellers 7, the flight altitude, or the weather (such as the pressure). Thus, the controller 3 may determine, based on not only the averages of the measured values B2, B3 as described above but also the variation per unit time or the variance thereof, for example, whether or not there is any imbalance in operation between the plurality of motors 1. Alternatively, the controller 3 may also determine, based on not only the total average but also the average of only the motors 1 arranged on one side, whether or not there is any imbalance in operation between the plurality of motors 1. As used herein, the “motors 1 arranged on one side” may refer to, for example, the motors 13, 14, and 15 arranged on the front side of the airframe 8 in FIG. 2. As used herein, the “front” side refers to the front in the traveling direction of the unmanned aerial vehicle 100. Note that the double-headed arrow indicating the forward/backward directions in FIG. 2 is just shown there as an assistant to description and is an insubstantial one.

Furthermore, the controller 3 makes reference to the response data M21-M26 to decide, when finding the result of self-diagnosis DE0 of any motor control device 2 abnormal, that the motor control device 2 should be operating improperly. In addition, if no response data M2 is acquired within a predetermined period of time since response data M2 has been acquired last time, then the controller 3 also decides that the motor control device 2 that has output the response data M2 should be operating improperly.

Each of the GPS modules 41, 42 is configured to obtain information about the current location (e.g., the latitude and longitude) of the unmanned aerial vehicle 100 by using a GPS as a positioning system. In this embodiment, the GPS modules 41, 42 have the same configuration, and therefore, the results of positioning obtained by the GPS modules 41, 42 should be the same unless there is any abnormality. The result of positioning obtained by the GPS module 41 is provided to the controller 31 and the result of positioning obtained by the GPS module 42 is provided to the controller 32.

The receiver 5 is configured to wirelessly communicate with, for example, a wireless communications device (transmitter 6) set up on the ground by using a radio wave as a propagation medium. The frequency band for use in the wireless communication may be compliant with, for example, the Specified Low-Power Radio Station (which is a wireless station requiring no license) standard that specifies the use of the 2.4 GHz band. The receiver 5 receives a main command transmitted from the transmitter 6 and passes the main command thus received to the controllers 31, 32. As used herein, the “main command” may include, for example, a target location to be reached by the unmanned aerial vehicle 100 and a time when the unmanned aerial vehicle 100 should arrive at the target location.

(3) Operation

Next, it will be described how the motor control system 10 and unmanned aerial vehicle 100 according to this embodiment operate. In the following description, the control unit 204 of every motor control device 2 is supposed to be controlling its associated motor 1 by using the control data M11 transmitted from the controller 31.

(3.1) Operation of Motor Control Device

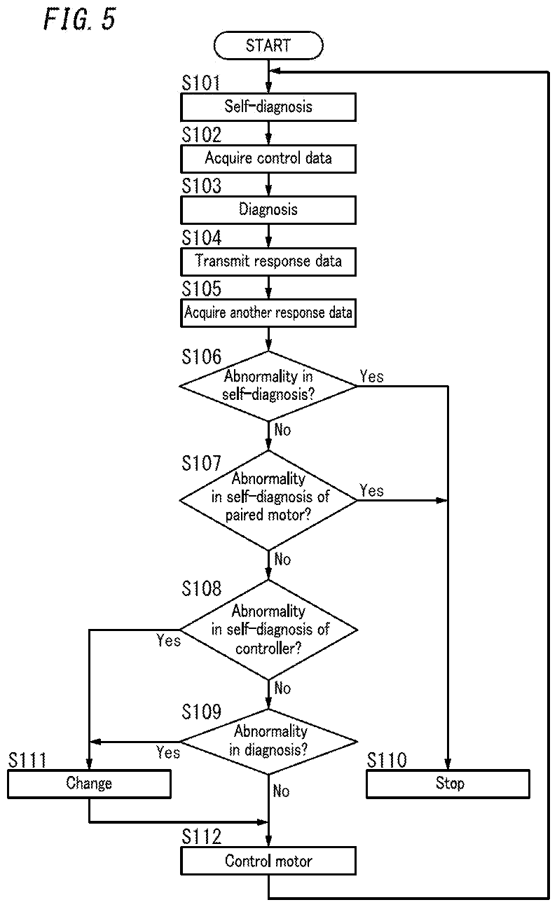

First, it will be described mainly with reference to FIG. 5 how the motor control device 2 operates. The motor control device 2 first has a diagnosis done by the self-diagnosis unit 203, thereby acquiring a result of self-diagnosis DE0 (in S101). Next, the motor control device 2 acquires control data M11, M12 from the controllers 31, 32, respectively (in S102). Then, the motor control device 2 has the diagnosis unit 202 make a diagnosis of the control data M11, M12, thereby acquiring a result of diagnosis DC0 (in S103). Thereafter, the control unit 204 of the motor control device 2 generates response data M2 and transmits the response data M2 thus generated to the controllers 31, 32 (in S104). At this time, the motor control device 2 acquires other response data M2 transmitted from the other motor control devices 2 (in S105).

Next, the control unit 204 of the motor control device 2 performs Steps S106-S109 to stop running its associated motor 1 (in S110) or perform control of its associated motor 1 (in S112). In the following description, the control unit 204 is supposed to perform these Steps S106, S107, S108, and S109 in this order. However, these Steps S106-S109 do not have to be performed in this order.

If the result of self-diagnosis DE0 acquired by itself indicates any abnormality (if the answer is YES in S106), then the control unit 204 stops running its associated motor 1 (in S110). In addition, if the control unit 204 finds, by reference to the other response data M22-M26, any abnormality in the result of self-diagnosis DE0 made by the motor control device 2 that controls the motor 1 paired with its associated motor 1 (if the answer is YES in S107), then the control unit 204 also stops running its associated motor 1 (in S110). As used herein, if the associated motor 1 is “paired with” another motor 1, then the latter motor 1 belongs to the same motor group as the associated motor 1. For example, the motor 1 paired with the motor 11 that is associated with the motor control device 21 is the motor 14 (see FIG. 2).

If the control unit 204 finds, by reference to the control data M11, M12, any abnormality in the result of self-diagnosis DF1 made by the controller 31 (if the answer is YES in S108), then the control unit 204 changes the control data M11 for use to control its associated motor 1 into the control data M12 (in S111). Note that when finding any abnormality in the result of self-diagnosis DF2 of the controller 32, the control unit 204 uses the control data M11 continuously. As can be seen, according to this embodiment, the motor control device 2 controls the motor 1 by using the control data M1 provided by one controller 3 that is selected based on the results of self-diagnosis DF0 made by the respective self-diagnosis units 302 of the plurality of controllers 3.

In addition, the control unit 204 also confirms the results of diagnosis DC0 made by all the motor control devices 2 by reference to the result of diagnosis DC0 made by itself and the other response data M22-M26. Then, when finding the control data M11 erroneous in any of the results of diagnosis DC0 made by all the motor control devices 2 (if the answer is YES in S109), then the control unit 204 also changes the control data M11 for use to control its associated motor 1 into the control data MI2 (in S111). Note that when finding the control data M12 erroneous, the control unit 204 uses the control data M11 continuously.

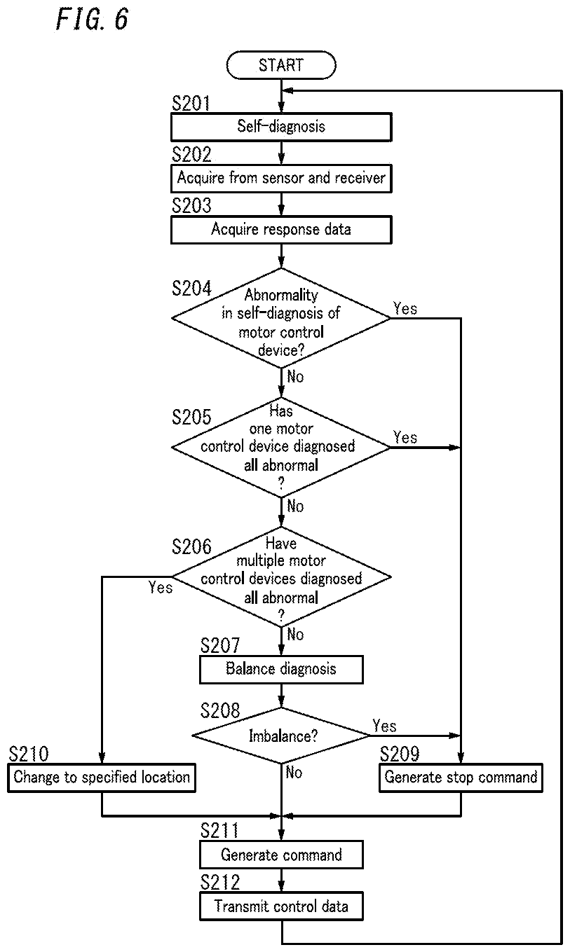

Next, it will be described mainly with reference to FIG. 6 how the controller 3 operates. First, the controller 3 has a diagnosis done by the self-diagnosis unit 302 to obtain a result of self-diagnosis DF0 (in S201). Next, the controller 3 acquires the result of detection by the sensor 301 and the main command received by the receiver 5 (in S202). In addition, the controller 3 receives and thereby acquires the response data M21-M26 from the motor control devices 21-26, respectively (in S203).

Next, the controller 3 performs Steps S204-S206 and Steps S207, S208, and then generates commands A0, including a stop command to be described later, with respect to the respective motor control devices 21-26 (in S211). Then, the controller 3 transmits control data M1, including the commands A0 thus generated and the result of self-diagnosis DF0, to the motor control devices 21-26 (in S212). In the following description, the controller 3 is supposed to perform these Steps S204-S207 (including Step S208) in this order. However, these Steps S204-S207 do not have to be performed in this order.

If the controller 3 finds, by reference to the response data M21-M26, any abnormality in the result of self-diagnosis DE0 made by any of the motor control devices 2 (if the answer is YES in S204), then the controller 3 generates a stop command to make the motor control device 2 stop running the motor 1 (in S209). In this embodiment, the controller 3 generates the stop command with respect to each of the motor 1 associated with the improperly operating motor control device 2 and another motor 1 belonging to the same motor group as the former motor 1. As can be seen, according to this embodiment, if there is any motor control device 2 selected based on the result of self-diagnosis DE0 made by the self-diagnosis unit 203, then the controller 3 stops running the motor 1 associated with the motor control device 2 and another motor 1 belonging to the same motor group as the former motor 1.

Suppose that when a motor 1 belonging to an arbitrary motor group is operating improperly, the motor 1 should be stopped. In that case, if the other motors 1 belonging to the same motor group continued running, then the unmanned aerial vehicle 100 would lose balance in its orientation, thus possibly making it difficult for the unmanned aerial vehicle 100 to continue its flight. That is to say, if any one of two or more motors 1 belonging to the same motor group stops running, the motor 1 that has stopped running could affect the balance in orientation of the unmanned aerial vehicle 100. Thus, according to this embodiment, the unmanned aerial vehicle 100 is allowed to maintain the balance in its orientation by stopping running all motors 1 belonging to the same motor group.

If the controller 3 fords, by reference to the response data M21-M26, one or more motor control devices 2, of which the results of diagnosis DC1, DC2 have both turned out to be abnormal (hereinafter referred to as “all abnormal”), then the controller 3 performs confirmation processing of confirming whether the result of diagnosis DC0 is correct or not. In other words, if the diagnosis unit 202 of one or more motor control devices 2, out of the plurality of motor control devices 2, diagnoses that the control data M1 provided by the plurality of controller 3 should be all erroneous, then each of the plurality of controllers 3 performs the confirmation processing.

Then, if the controller 3 finds, during the continuation processing, that only one motor control device 2 has diagnosed “all abnormal” (if the answer is YES in S205), then the controller 3 decides that the motor control device 2 should be operating improperly. Then, the controller 3 generates a stop command with respect to the motor 1 associated with the improperly operating motor control device 21 and another motor 1 belonging to the same motor group as the motor 1 (in S209). In other words, if the controller 3 finds, during the confirmation processing, that there is only one motor control device 2, of which the diagnosis unit 202 has determined the control data to be erroneous, then each of the controllers 3 stops the motor 1 associated with the one motor control device 2 and another motor 1 belonging to the same motor group as the motor 1.

On the other hand, if the controller 3 finds, during the confirmation processing, that a plurality of motor control devices 2 have diagnosed “all abnormal” (if the answer is YES in S206), then the controller 3 decides that an external device should be operating improperly. In other words, if the controller 3 finds, during the confirmation processing, that there are a plurality of motor control devices 2, of which the diagnosis unit 202 have determined the control data erroneous, then each of the controllers 3 decides that an external device communicating with each of the plurality of controllers 3 should be operating improperly. As used herein, the “external device” may be the receiver 5 and the transmitter 6, for example. Then, the controller 3 changes the target location to be reached by the unmanned aerial vehicle 100 from the target location defined by the main command into a prescribed specified location (in other words, an evacuation location) (in S210).

The controller 3 uses the balance diagnosis capability to make a diagnosis of the balance in operation between the motors 11-16 (in S207). Then, if any imbalance is detected as a result of the balance diagnosis (if the answer is YES in S208), then the controller 3 generate a stop command with respect to each of the motors 1 contributing to the imbalance and another motor 1 belonging to the same motor group as the motor 1 (in S209).

As can be seen from the foregoing description, according to this embodiment, the control unit 204 controls its associated motor 1 by using a single set of control data M1 which is selected based on the result of diagnosis DC0 made by the diagnosis unit 202 from the multiple sets of council data M1. For example, suppose that the diagnosis unit 202 has diagnosed that the control data M11 transmitted from one controller 31, out of the plurality of controllers 3, should be erroneous. In that case, the control unit 204 may control its associated motor 1 by using the control data M12 transmitted from a controller 32 different from the controller 31 that is the source of the control data M11 that has been diagnosed to be erroneous.

When any semiconductor component has become defective extemporaneously due to some external factor such as vibration or heat in the sensor 301 built in the controller 3 or a microcontroller, for example, the controller 3 may start operating improperly (i.e., may cause some abnormality). Even in such a situation, according to this embodiment, the control data M1 transmitted from a controller 3 different from the normally used controller 3 may be used, thus achieving the advantage of facilitating controlling the motor 1 continuously.

In addition, according to this embodiment, another controller 3 just needs to be provided additionally. Thus, there is no need to add a motor control device 2, which is more expensive and heavier than the controller 3, or any of a power supply harness, a switching circuit, or a parachute, for example. Thus, this embodiment achieves the advantage of reducing an increase in the weight and cost of the unmanned aerial vehicle 100 more easily while ensuring continuity of control of the motor 1.

(4) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Also, the same function as that of the motor control system 10 may be implemented as a motor control method, a computer program, or a non-transitory storage medium that stores the computer program thereon, for example.

A motor control method according to an aspect includes making a diagnosis of control data M1. The control data M1 includes a command, transmitted from each of a plurality of controllers 3, with respect to a motor 1. The motor control method includes controlling the motor 1 by using a single set of control data M1, which is selected based on a result of diagnosis DC0 from multiple sets of the control data M1 provided by the plurality of controllers 3.

Next, variations of the exemplary embodiment will be enumerated one after another. Note that the variations to be described below may be adopted in combination as appropriate.

The motor control device 2 (or controller 3) according to the present disclosure includes a computer system. In that case, the computer system may include, as principal hardware components, a processor and a memory. The functions of the motor control device 2 (or controller 3) according to the present disclosure may be performed by making the processor execute program stored in the memory of the computer system. The program may be stored in advance in the memory of the computer system. Alternatively, the program may also be downloaded through a telecommunications line or be distributed after having been recorded in some non-transitory storage medium such as a memory card an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra-large scale integrated circuit (ULSI). Optionally, a field-programmable gate army (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of constituent elements (or the functions) of the motor control device 2 (or controller 3) are integrated together in a single housing. However, this is not an essential configuration for the motor control device 2 (or controller 3) and should not be construed as limiting. That is to say, those constituent elements (or functions) of the motor control device 2 (or controller 3) may be distributed in multiple different housings. Still alternatively, at least some functions of the motor control device 2 (or controller 3) may be implemented as a cloud computing system, for example, as well.

Furthermore, in each of the plurality of motor control devices 2, the diagnosis unit 202 may make a diagnosis of not only the control data M1 for the motor control device 2 itself but also the control data M1 for another motor control device 2 as well. In that case, if there are a predetermined number of (e.g. a half or more) motor control devices 2, which have determined the control data M1 to be erroneous, for example, then a decision may be made that the controller 31 should be operating improperly. On the other hand, if a decision is made that the control data M11 has found to be erroneous by only one motor control device 2 but errorless by all the other motor control devices 2, then the motor control device 2 that has found the control data M11 erroneous may be determined to be operating improperly.

Furthermore, if a decision has been made that not the control data M11 normally used but the control data M12 transmitted from the controller 32 should be erroneous, then the controller 31 may notify a high-order system that the controller 32 is operating improperly. As used herein, the “high-order system” may be, for example, a management system run by a business operator who provides the service of using the unmanned aerial vehicle 100.

Optionally, the unmanned aerial vehicle 100 may include three or more controllers 3. In that case, the control data M1 may be transmitted from either all the controllers 3 or from two out of the three controllers 3 as in the embodiment described above, whichever is appropriate. In the latter case, the two controllers 3 correspond to the “plurality of controllers” in the exemplary embodiment described above and the other controller 3 corresponds to a “reserved (another) controller.”

If a diagnosis has been made that the control data M1 transmitted from one of the two controllers 3 should be erroneous, then the control data M1 may be transmitted from the other controller 3 and one of the reserved controllers 3. In other words, if the diagnosis unit 202 has made a diagnosis that any one set of control data M1, out of multiple sets of control data M1, should be erroneous, then the motor control device 2 may acquire the control data M1 from another controller 3 which is provided separately from the plurality of controllers 3.

Furthermore, each of the plurality of controllers 3 may be implemented as an independent package or all of the plurality of controllers 3 may be housed in a single package. For example, two controllers 3 may be implemented as a package having a single dual-core processor. In that case, the two cores correspond to the two controllers 3, respectively.

Optionally, the unmanned aerial vehicle 100 may include only one controller 3 instead of the plurality of controllers 3. Such an implementation does not allow each of the plurality of motor control devices 2 to select a single set of control data M11 from multiple sets of control data M1 transmitted from a plurality of controllers 3. Even in such an implementation, however, if there is a motor control device 2 selected based on the result of self-diagnosis DF0 made by the self-diagnosis unit 203, then the controller 3 may also stop running the motor 1 associated with the motor control device 2 and another motor 1 belonging to the same motor group as the former motor 1.

Furthermore, the motor control system 10 does not have to be used in the unmanned aerial vehicle 100 but may also be used in a moving vehicle such as an electric vehicle, for example. That is to say, the moving vehicle (such as an electric vehicle) may include the motor control system 10 and a moving mechanism (such as wheels and tires) that moves by driving the motor 1.

(Resume)

As can be seen from the foregoing description, a motor control system (10) according to a first aspect includes a motor (1) and a motor control device (2) provided for the motor (1). The motor control device (2) includes an acquisition unit (201), a diagnosis unit (202), and a control unit (204). The acquisition unit (201) acquires control data (M1). The control data (M1) includes a command (A0), transmitted from each of a plurality of controllers (3), with respect to the motor (1). The plurality of controllers (3) are configured to communicate with the motor control device (2). The diagnosis unit (202) makes a diagnosis of multiple sets of the control data (M1) provided by the plurality of controllers (3) and acquired by the acquisition unit (201). The control unit (204) controls the motor (1) by using a single set of control data (M1), selected based on a result of the diagnosis (DC0) made by the diagnosis unit (202), from the multiple sets of the control data (M1).

This aspect achieves the advantage of facilitating controlling the motor (1) continuously.

In a motor control system (10) according to a second aspect, which may be implemented in conjunction with the first aspect, the motor control device (2) acquires a result of diagnosis (DC0) made by the diagnosis unit (202) of another motor control device (2).

According to this aspect, every motor control device (2) uses the same control data (M1) based on a result of diagnosis (DC0) made by another motor control device (2), thus achieving the advantage of unifying the operation of the respective motor control devices (2) easily.

In a motor control system (10) according to a third aspect, which may be implemented in conjunction with the first or second aspect, the motor control device (2) has the capability of transmitting the result of diagnosis (DC0) made by the diagnosis unit (202).

This aspect achieves the advantage of allowing a result of diagnosis (DC0) to be shared by a controller (3) by transmitting the result of diagnosis (DC0) to the controller (3), for example.

In a motor control system (10) according to a fourth aspect, which may be implemented in conjunction with any one of the first to third aspects, each of the plurality of controllers (3) generates the control data (M1) based on a result of detection by an associated one of a plurality of sensors (301). The plurality of sensors (301) are associated one to one with the plurality of controllers (3).

This aspect achieves, no matter which of the sensors (301) is operating improperly, the advantage of facilitating controlling the motor (1) continuously by using control data (M1) provided by a controller (3) that uses a sensor (301) operating normally.

In a motor control system (10) according to a fifth aspect, which may be implemented in conjunction with any one of the first to fourth aspects, each of the plurality of controllers (3) includes a self-diagnosis unit (302) to make a diagnosis of the controller (3) itself Each of the multiple sets of control data (M1) further includes a result of self-diagnosis (DF0) made by the self-diagnosis unit (302) of its associated controller (3).

This aspect achieves the advantage of shortening, compared to a situation where each of the plurality of controllers (3) transmits the result of self-diagnosis (DF0) made by the self-diagnosis unit (302) separately from the control data (M1), the time it takes to establish communication with the motor control device (2).

In a motor control system (10) according to a sixth aspect, which may be implemented in conjunction with any one of the first to fifth aspects, the motor (1) includes a plurality of motors (1), the motor control device (2) includes a plurality of motor control devices (2), and each of the plurality of motor control devices (2) controls an associated one of the plurality of motors (1).

This aspect achieves the advantage of facilitating controlling one or more motors (1) out of the plurality of motors (1) continuously.

In a motor control system (10) according to a seventh aspect, which may be implemented in conjunction with the sixth aspect, each of the plurality of controllers (3) broadcasts the control data (M1) to the plurality of motor control devices (2).

This aspect achieves the advantage of facilitating shortening, compared to a situation where the control data (M1) is unicast one by one to each of the plurality of motor control devices (2), the time it takes to establish communication with the plurality of motor control devices (2).

In a motor control system (10) according to an eighth aspect, which may be implemented in conjunction with any one of the first to seventh aspects, each of the plurality of controllers (3) includes a self-diagnosis unit (302) to make a diagnosis of the controller (3) itself. The motor control device (2) controls an associated motor (1) by using the control data (M1) provided by one controller (3) which is selected based on a result of self-diagnosis (DF0) made by the self-diagnosis unit (302) of each of the plurality of controllers (3).

This aspect achieves, even if one of the plurality of controllers (3) is operating improperly, for example, the advantage of facilitating controlling the motor (1) continuously by using the control data (M1) provided by another controller (3).

In a motor control system (10) according to a ninth aspect, which may be implemented in conjunction with any one of the first to eighth aspects, the motor control device (2) performs the following processing. Specifically, when the diagnosis unit (20) diagnoses that. any one of the multiple sets of control data (M1) should be erroneous, the motor control device (3) acquires control data (M1) from another controller (3) provided separately from the plurality of controllers (3).

This aspect achieves, when two controllers (3) out of three or more controllers (3) are used as the plurality of controllers (3), for example, the following advantage. Specifically, this aspect achieves, even if one of the two controllers (3) has become unavailable, the advantage of allowing another controller (3), provided separately from the two controllers (3), to compensate for the unavailability of one of the plurality of controllers (3).

An unmanned aerial vehicle (100) according to a tenth aspect includes a plurality of motors (1), a plurality of motor control devices (2), and a controller (3). The plurality of motors (1) spin a plurality of propellers, respectively. The plurality of motor control devices (2) control the plurality of motors (1), respectively. The controller (3) is configured to communicate with the plurality of motor control devices (2) and transmits control data (M1), including commands (A0) with respect to the plurality of motors (1), to the plurality of motors (1). The plurality of motors (1) are classified into multiple motor groups (1). Each of the multiple motor groups (1) includes two or more motors (1). Each of the plurality of motor control devices (2) includes a self-diagnosis unit (203) to make a diagnosis of the motor control device (2) itself. When there is any motor control device (2) to be selected based on a result of self-diagnosis (DE0) by the self-diagnosis unit (203), the controller (3) stops running a particular one of the motors (1) that is associated with the motor control device (2) and at least one more of the motors (1) that belongs to the same motor group as the particular motor (1).

According to this aspect, if one of the plurality of motor control devices (2) is operating improperly, for example, the motor (1) affected by the improperly operating motor control device (2) is stopped. Thus, this aspect achieves the advantage of facilitating controlling the motor (1) (in other words, controlling the flight of the unmanned aerial vehicle (100)) continuously.

In an unmanned aerial vehicle (100) according to an eleventh aspect, which may be implemented in conjunction with the tenth aspect, the controller (3) includes a plurality of controllers (3). Each of the plurality of motor control devices (2) includes a diagnosis unit (202) to make a diagnosis of multiple sets of the control data (M1) provided by the plurality of controllers (3). When the diagnosis unit (202) in one or more of the plurality of motor control devices (2) diagnoses that, all of the multiple sets of the control data (M1) provided by the plurality of controllers (3) are erroneous, each of the plurality of controllers (3) performs confirmation processing. The confirmation processing includes confirming whether the result of the diagnosis (DC0) is correct or not.

According to this aspect, even if a diagnosis has been made that all of the multiple sets of control data (M1) provided by the plurality of controllers (3) should be erroneous, confirmation is made which of the plurality of controllers (3) and the one or more motor control devices (2) is operating properly. Thus, this aspect achieves the advantage of facilitating controlling the motor (1) (in other words, controlling the flight of the unmanned aerial vehicle (100)) continuously.

In an unmanned aerial vehicle (100) according to a twelfth aspect, which may be implemented in conjunction with the eleventh aspect, when there is a single motor control device (2), of which the diagnosis unit (202) determines the control data (M1) to be erroneous, each of the plurality of controllers (3) performs the following processing as the confirmation processing. Specifically, each of the controllers (3) stops running a particular motor (1) associated with the single motor control device (2) and at least one more motor (1) belonging to the same motor group as the particular motor (1).

This aspect allows, when a motor control device (2) that has made the diagnosis is determined to be operating improperly, a motor (1) affected by the improperly operating motor control device (2) to be stopped. Thus, this aspect achieves the advantage of facilitating controlling the motor (1) (in other words, controlling the flight of the unmanned aerial vehicle (100)) continuously.

In an unmanned aerial vehicle (100) according to a thirteenth aspect, which may be implemented in conjunction with the eleventh aspect, when there are a plurality of motor control devices (2), of which respective the diagnosis units (202) determine the control data (M1) to be erroneous, each of the plurality of controllers (3) performs the following processing as the confirmation processing. Specifically, each of the plurality of controllers (3) determines that an external device (such as a receiver (5) or a transmitter (6)) communicating with each of the plurality of controllers (3) should be operating improperly.

This aspect achieves the advantage of allowing the unmanned aerial vehicle (100) to fly to an appropriate location easily irrespective of a command (A0) from an external device, for example, by determining that the external device should be operating improperly.

A moving vehicle (such as an electric vehicle) according to a fourteenth aspect includes: the motor control system (10) according to any one of the first to eighth aspects; and a moving mechanism (such as wheels and tires) to move when the motor (1) is driven.

This aspect facilitates controlling the motor (1) (in other words, controlling the movement of the moving vehicle) continuously.

A motor control method according to a fifteen aspect includes making a diagnosis of control data (M1). The control data (M1) includes a command (A0), transmitted from each of a plurality of controllers (3), with respect to a motor (1). The motor control method includes controlling the motor (1) by using a single set of control data (M1), which is selected based on a result of diagnosis (DC0) from multiple sets of the control data (M1) provided by the plurality of controllers (3).

This aspect facilitates controlling the motor (1) continuously.

Note that the constituent elements according to the second to ninth aspects are not essential constituent elements fore the motor control system (10) but may he omitted as appropriate. In addition, the constituent elements according to the eleventh to thirteenth aspects are not essential constituent elements for the unmanned aerial vehicle (100) but may he omitted as appropriate.

### REFERENCE SIGNS LIST

1, 11-16 Motor

2, 21-26 Motor Control Device

201 Acquisition Unit

202 Diagnosis Unit

203 Self-Diagnosis Unit

204 Control Unit

3, 31, 32 Controller

301 Sensor

302 Self-Diagnosis Unit

5 Receiver (External Device)

6 Transmitter (External Device)

7 Propeller

10 Motor Control System

100 Unmanned Aerial Vehicle

A0, Am1, . . . , Amn Command

DC0, DC1, . . . DCm Result of Diagnosis

DE0, DEn Result of Self-Diagnosis

DF0, DFm Result of Self-Diagnosis

M1, M11, M12 Control Data

1. A motor control system comprising,:
a motor; and
a motor control device provided for the motor,
the motor control device including:
an acquisition unit configured to acquire control data including a command, transmitted from each of a. plurality of controllers, with respect to the motor, the plurality of controllers being configured to communicate with the motor control device:
a diagnosis unit configured to make a diagnosis of multiple sets of the control data provided dry the plurality of controllers and acquired by the acquisition unit; and
a control unit configured to control the motor by using a single set of control data selected, based on a result of the diagnosis made by the diagnosis unit, from the multiple sets of the control data.

2. The motor control system of claim 1, wherein
the motor control device is configured to acquire a result of diagnosis made by the diagnosis unit of another motor control device

3. The motor control system of claim 1, wherein
the motor control device has the capability of transmitting the result of diagnosis made by the diagnosis unit.

4. The motor control system of claim 1, wherein
each of the plurality of controllers is configured to generate the control data based on a result of detection by an associated one of a plurality of sensors, the plurality of sensors being associated one to one with the plurality of controllers.

5. The motor control system of claim 1, wherein
each of the plurality of controllers includes a self-diagnosis unit configured to make a diagnosis of the controller itself, and
each of the multiple sets of control data further includes a result of self-diagnosis made by the self-diagnosis unit of its associated controller.

6. The motor control system of claim 1, wherein
the motor includes a plurality of motors, the motor control device includes a plurality of motor control devices, and
each of the plurality of motor control devices is configured to control an associated one of the plurality of motors.

7. The motor control system of claim 6, wherein
each of the plurality of controllers is configured to broadcast the control data to the plurality of motor control devices.

8. The motor control system of claim 1, wherein
each of the plurality of controllers includes a self-diagnosis unit configured to make a diagnosis of the controller itself, and
the motor control device is configured to control its associated motor by using the control data provided by one controller, the one controller being selected based on a result of self-diagnosis made by the self-diagnosis unit of each of the plurality of controllers.

9. The motor control system of claim 1, wherein
the motor control device is configured to, when the diagnosis unit diagnoses that any one of the multiple sets of control data be erroneous, acquire control data from another controller provided separately from the plurality of controllers.

10. An unmanned aerial vehicle comprising:
a plurality of motors configured to spin a plurality of propellers, respectively;
a plurality of motor control devices configured to control the plurality of motors, respectively; and
a controller configured to communicate with the plurality of motor control devices and configured to transmit control data, including commands with respect to the plurality of motors, to the plurality of motors,
the plurality of motors being classified into multiple motor groups, each of the multiple motor groups including two or more motors,
each of the plurality of motor control devices including a self-diagnosis unit configured to make, a diagnosis of the motor control device itself,
the controller being configured to, when there is any motor control device to be selected based on a result of self-diagnosis by the self-diagnosis unit, stop running a particular one of the motors that is associated with the motor control device and at least one more of the motors that belongs to the same motor group as the particular motor.

11. The unmanned aerial vehicle of claim 10, wherein
the controller includes a plurality of controllers,
each of the plurality of motor control devices includes a diagnosis unit configured to make a diagnosis of multiple sets of the control data provided by the plurality of controllers, and
each of the plurality of controllers is configured to, when the diagnosis unit in one or more of the plurality of motor control devices diagnoses that, all of the multiple sets of the control data provided by the plurality of controllers are erroneous, perform confirmation processing of confirming whether the result of the diagnosis is correct or not.

12. The unmanned aerial vehicle of claim 11, wherein
each of the plurality of controllers is configured to, when there is a single motor control device, of which the diagnosis unit determines the control data to be erroneous, stop, as the confirmation processing, running a particular motor associated with the single motor control device and at least one more motor belonging to the same motor group as the particular motor.

13. The unmanned aerial vehicle of claim 11, wherein
each of the plurality of controllers is configured to, when there are a plurality of motor control devices, of which respective the diagnosis units determine the control data to be erroneous, determine, as the confirmation processing, that an external device communicating with each of the plurality of controllers be operating improperly.

14. A moving vehicle comprising:
the motor control system of claim 1; and
a moving mechanism configured to move when the motor is driven.

15. A motor control method comprising:
making a diagnosis of control data including a command, transmitted from each of a plurality of controllers, with respect to a motor; and
controlling the motor by using a single set of control data, which is selected based on a result of diagnosis from multiple sets of the control data provided by the plurality of controllers.
